(19) United States
(12) Patent Application Publication
(10) Pub. No.: US 2009/0250038 A1
(43) Pub. Date: Oct. 8, 2009

(54) FLOW SENSING FUEL SYSTEM

(76) Inventors: Wenbin Xu, Pittsford, NY (US); Leonard L. Shebert, Pittsford, NY (US); Jay K. Sofianek, Webster, NY (US)

Correspondence Address: DELPHI TECHNOLOGIES, INC., M/C 480-410-202, PO BOX 5052, TROY, MI, 48007, US

(21) Appl. No.: 12/080,867

(22) Filed: Apr. 7, 2008

(51) Int. Cl. F02D 1/00; F02M 69/54; G06F 19/00

(52) U.S. Cl. 123/457; 701/103; 701/113; 701/112

(57) ABSTRACT

A flow sensing fuel system for multiple port fuel injection gasoline engines, gasoline direct injection engines, or common rail diesel engines include a flow monitoring device positioned in a fuel flow passage between a fuel pump and a fuel rail, a fuel pressure sensor in fluid communication with said fuel rail, and a controllable pressure regulator closing to a fuel tank. By integrating flow monitoring device, fuel pressure sensor, and controllable pressure regulator in existing fuel systems, a flow sensing fuel system is provided that protects the engine and limits the fuel leaking into the environment in case of a stuck open condition or sealing problem of one or more injectors or in case of a leak in the fuel rail assembly. The flow sensing fuel system enables monitoring the fuel flow during engine start-up, during engine operation, and after engine shut down.

### TECHNICAL FIELD

The present invention relates to fuel systems for spark ignited and compression ignited engines; more particularly, to multiple port fuel injection (MPFI) and gasoline direct injection (GDI) fuel systems for spark ignited engines and common rail fuel systems for compression ignited engines with closed loop control; and most particularly, to a flow sensing fuel system and method for monitoring the fuel flow in a fuel system under real time engine conditions.

### BACKGROUND OF THE INVENTION

Multiple port fuel injection (MPFI) and gasoline direct injection (GDI) fuel systems for spark ignited engines and common rail fuel systems for compression-ignited engines with closed loop control are well known. Engine management systems (EMS) of such prior art internal combustion engines typically include a fuel injection system (also referred to herein simply as fuel system), an emission diagnostic system, and an air flow meter that all interact with a powertrain control module (also referred to herein simply as engine control module). The fuel injection system typically includes fuel injectors connected via a fuel rail and a fuel pump to a fuel tank. The emission diagnostic system measures the combustion air to fuel (A/F) ratio from the exhaust gas and may include an oxygen sensor or an A/F sensor. The air flow meter measures the flow of intake air and may include an intake air temperature sensor. To supply fuel to a MPFI gasoline engine, an injector is installed into an engine intake manifold or cylinder head. To supply fuel to a compression ignited engine or GDI gasoline engine, an injector is inserted into an engine combustion chamber. The fuel inlet of the injector is typically connected to a fuel rail where fuel under relatively high pressure is contained. To achieve closed loop fuel or exhaust gas recirculation (EGR) quantity control, the oxygen or A/F sensor and the air flow meter are typically used to provide measurement data to the powertrain control module, which sends control signals to the fuel system after evaluating the received data.

Drawbacks of the prior art include, for example, that a hydraulic lock caused by large fuel leakage in one or more cylinders of the engine currently cannot be detected after engine shut down. Hydraulic lock of an engine is typically caused by a stuck open condition or a gross seat leakage condition of one or multiple injectors causing a volume of unwanted and incompressible fuel to accumulate in the combustion chamber. Hydraulic lock of an engine most often occurs during engine start-up after shutdown. Injector manufacturers try, from both a design and a process standpoint, to prevent stuck open or gross seat leakage conditions by eliminating contamination of the injectors as much as possible. However, under current manufacturing processes stuck open or gross seat leakage conditions cannot be eliminated completely. As a result, engine damage due to stuck open or gross seat leakage conditions occur both in assembly plants and in customer use.

Furthermore, with current closed loop control for fuel systems it may be possible for measurable amounts of liquid fuel and fuel vapors to escape uncontrolled from the fuel system and into the external environment from a stuck open or gross seat leakage condition.

In general, fuel pressure pulsation occurs in current fuel systems during injector operation. The pressure pulsation can cause audible noise and induce fuel metering variations within a given injector or injector-to-injector.

Furthermore, current commercial fuel systems cannot protect the engine from damage due to stuck open or gross seat leakage conditions. The A/F ratio signal from exhaust gas typically measured by current commercial engine management systems (EMS) can be used to help detect and monitor a stuck open injector or a leaking injector during engine operation. However, this approach cannot detect a stuck open injector or a seat leakage condition during engine start-up after shut down. Furthermore, this approach cannot be used to detect fuel leakage from the fuel system into the external environment.

What is needed in the art is a means for detecting a stuck open and/or gross seat leakage condition in fuel systems during all engine operating conditions including during start-up.

It is a principal object of the present invention to provide a fuel system that enables detection of stuck open and/or gross seat leakage conditions of one or more fuel injectors and the detection of fuel leaks from the fuel system to the external environment during engine start-up, during engine operation, and after shut down of engine operation.

It is a further object of the present invention to provide a fuel flow sensing function to a commercially available fuel system of gasoline and diesel engines.

### SUMMARY OF THE INVENTION

Briefly described, a fuel system in accordance with the invention includes a flow monitoring device, such as a flow limit valve, a continuous position identification valve, or a flow meter, a fuel pressure sensor, and a controllable pressure regulator in combination with a prior art oxygen or A/F sensor to monitor the fuel flow under real time engine operations. In one aspect of the invention, the flow monitoring device, the fuel pressure sensor, and the controllable pressure regulator are integrated into a MPFI fuel system. In another aspect of the invention, for GDI engines and common rail diesel engines, which have included a controllable pressure regulator, only the flow monitoring device needs to be integrated into the fuel system.

By including the monitoring device, the fuel pressure sensor, and the controllable pressure regulator in the fuel system of a gasoline or diesel engine, identification of an injector malfunction, such as a stuck open or gross seat leakage condition or fuel leakage to the external environment is enabled during engine start-up, during engine operation, and after engine shut down. As a result, the engine can be protected from hydraulic lock and leakage of fuel into the external environment can be prevented.

In yet another aspect of the invention, the flow limit valve also operates as a damper to reduce fuel pressure pulsations. Consequently, noise and fuel metering variations within a given injector and injector to injector can be reduced.

### BRIEF DESCRIPTION OF THE DRAWINGS

The present invention will now be described, by way of example, with reference to the accompanying drawings, in which:

FIG. 1 is a schematic diagram of a flow sensing fuel system for MPFI gasoline engine applications in accordance with the invention;

FIG. 2 is a schematic diagram of control signals utilized by the fuel system of FIG. 1 in accordance with the invention;

FIG. 3 is a flow chart of system control logic of the fuel system of FIG. 1 during engine operation in accordance with the invention;

FIG. 4 is a flow chart of system control logic of the fuel system of FIG. 1 during engine start-up in accordance with the invention; and

FIG. 5 is a flow chart of system control logic of the fuel system of FIG. 1 after engine shut down in accordance with the invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DESCRIPTION OF THE PREFERRED EMBODIMENTS

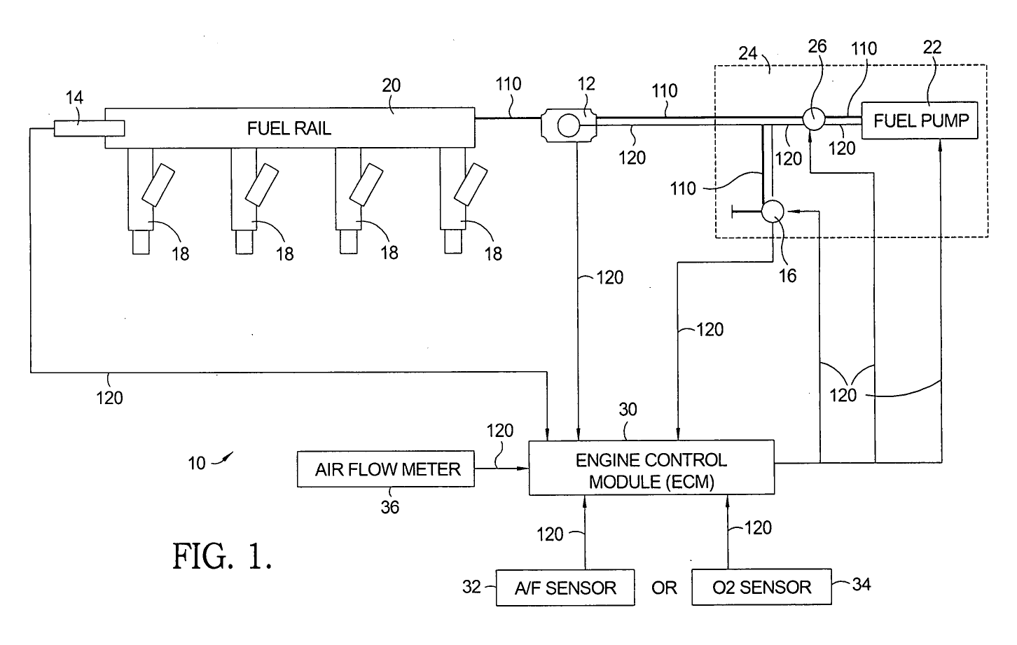

Referring to FIG. 1, a flow sensing fuel system 10 for MPFI engine applications includes a flow monitoring device 12, a fuel pressure sensor 14, and a controllable pressure regulator 16 as additional elements of a current commercial fuel system. To supply fuel to an MPFI engine (not shown) multiple injectors 18 are included in the fuel system 10. The fuel inlet of each injector 18 is connected to a fuel rail 20. Fuel is pumped by a fuel pump 22 from a fuel tank 24 to fuel rail 20. A controllable check valve 26 in fuel tank 24 may be included to control the fuel flow supplied by fuel pump 22. Flow monitoring device 12 is positioned in the flow passage between fuel pump 22 and fuel rail 20 and monitors the fuel flow from fuel pump 22 to fuel rail 20. Fuel pressure sensor 14 is in fluid communication with fuel rail 20 and monitors the fuel pressure in fuel rail 20. Flow monitoring device 12 and fuel pressure sensor 14 provide input data lo to an engine control module (ECM) 30. The engine control module 30 may further receive information from an A/F sensor 32 or oxygen sensor 34 and an air flow meter 36. Flow monitor device 12 and fuel pressure sensor 14 may be used to detect a stuck open condition in one or more injectors 18 as well as gross leaks in fuel rail 20 or one or more injectors 18 during engine start-up, during engine operation, and after engine shut down. Information from A/F sensor 32 or oxygen sensor 34 may be used for detection of injector stuck open conditions and leaks to the external environment during engine operation only. Air flow meter 36 monitors the intake airflow during engine start-up and during engine operation. Controllable pressure regulator 16 is positioned at an outlet of fuel pump 22. Controllable pressure regulator 16 and fuel pump 22 receive commands from ECM 30 to stop fuel supply from fuel pump 22 to fuel rail 20. In some operating conditions, fuel pump 22 may receive commands from ECM 30 to reverse operation of fuel pump 22 to draw back fuel from fuel rail 20 to fuel tank 24 in the event that an abnormal flow in fuel system 10 is detected. Fuel pump 22, controllable check valve 26, controllable pressure regulator 16, flow monitoring device 12, and fuel rail 20 are in fluid communication through fuel flow passages 110. Electrical connections 120 exist between ECM 30, fuel pump 22, controllable check valve 26, controllable pressure regulator 16, flow monitoring device 12, fuel rail 20, fuel pressure sensor 14, air flow meter 36, and A/F sensor 32 or oxygen sensor 34.

Pressure sensor 14 may be a commercially available product. For controllable pressure regulator 16, an on/off function is required for application in fuel system 10. Flow monitoring device 12 should enable monitoring of multiple flow rates for application in fuel system 10 and may be a commercially available product or an application specific customized product. Flow monitoring device 12 may be, for example, an on/off flow control valve that allows flow in an open position and that is tripped automatically when the flow rate exceeds a certain preset value preventing any further flow, or a continuous position identification valve that enables monitoring valve positions under different flow rates, or a flow meter, which is basically a flow metering valve.

Even though fuel system 10 is shown in FIG. 1 for MPFI gasoline engine applications, current commercial fuel systems for gasoline direct injection (GDI) gasoline engines and common rail diesel engines may be converted to flow sensing fuel system 10 by integrating flow monitoring device 12, and controllable pressure regulator 16 if necessary into the existing fuel system according to the above description.

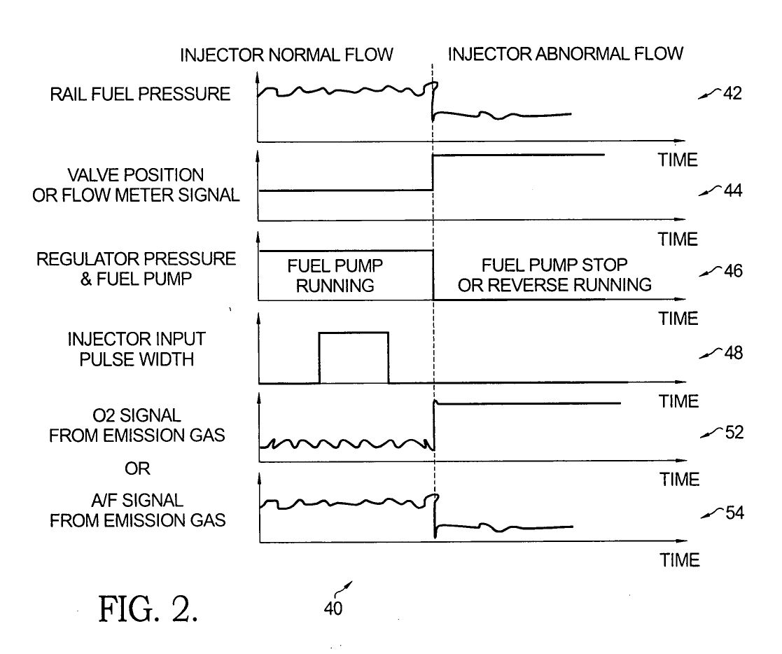

Referring to FIG. 2, control signals 40 utilized by flow sensing fuel system 10 include rail fuel pressure signal 42, valve position or flow meter signal 44, regulator pressure signal 46, injector input pulse 48, oxygen signal 52 from emission gas or A/F signal 54 from emission gas. The rail fuel pressure signal 42 can be monitored with fuel pressure sensor 14 (FIG. 1). Valve position or flow meter signal 44 may be monitored with flow monitoring device 12 (FIG. 1). Regulator pressure signal 46 is controlled by ECM 30 and activates or deactivates pressure regulator 16 (both shown in FIG. 1). Oxygen signal 52 is supplied by oxygen sensor 34 and A/F signal 54 is supplied by A/F sensor 32.

As can be seen, control signals 40 for a normal fuel flow for injectors 18 differ from control signals 40 for abnormal fuel flow for injectors 18. A decrease in rail fuel pressure signal 42 indicates an abnormal change in the fuel pressure in the fuel rail, which may be caused by increased flow due to a stuck open injector 18, an injector 18 with a gross seat leakage condition, or a leak to the external environment in the fuel rail 20. An abnormal change in valve position or an increase of flow meter signal 44 also indicates a change in the fuel flow through fuel rail 20 and/or injector 18. A stuck open injector 18 or a gross leak in fuel rail 20 or at the seal between injector 18 and fuel rail 20 may result in an increased flow of fuel through flow monitoring device 12. Regulator pressure signal 46 and thus operation of fuel pump 22 are controlled by ECM 30. Regulator pressure signal 46 activates or deactivates controllable pressure regulator 16 to control fuel pressure in flow sensing fuel system 10. If regulator pressure signal 46 is on, fuel pump 22 is running. If regulator pressure signal 46 is off, operation of fuel pump 22 is stopped to end fuel supply from fuel pump 22 to fuel rail 20 and operation of fuel pump 22 may be reversed to draw back fuel from fuel rail 20 in case of detection of a stuck open injector 18 or a leak to the external environment, for example, in fuel rail 20. Injector pulse width 48 will be turned off by ECM 30 when fuel flow to or through injector 18 is confirmed as abnormal. Oxygen signal 52 of emission gas may increase abnormally while the A/F signal 54 for emission gas may decrease with an abnormal injector flow during engine operation.

Control signals 42, 44, 48, 52, and 54 may be received as input signals by engine control module (ECM) 30 (FIG. 1) during engine operation while control signal 46 may be sent out by ECM 30 as an output signal. During engine start-up, only control signals 42, 44, 46, and 48 may be utilized by fuel system 10. After engine shut down, only control signals 42, 44, and 46 may be utilized by fuel system 10.

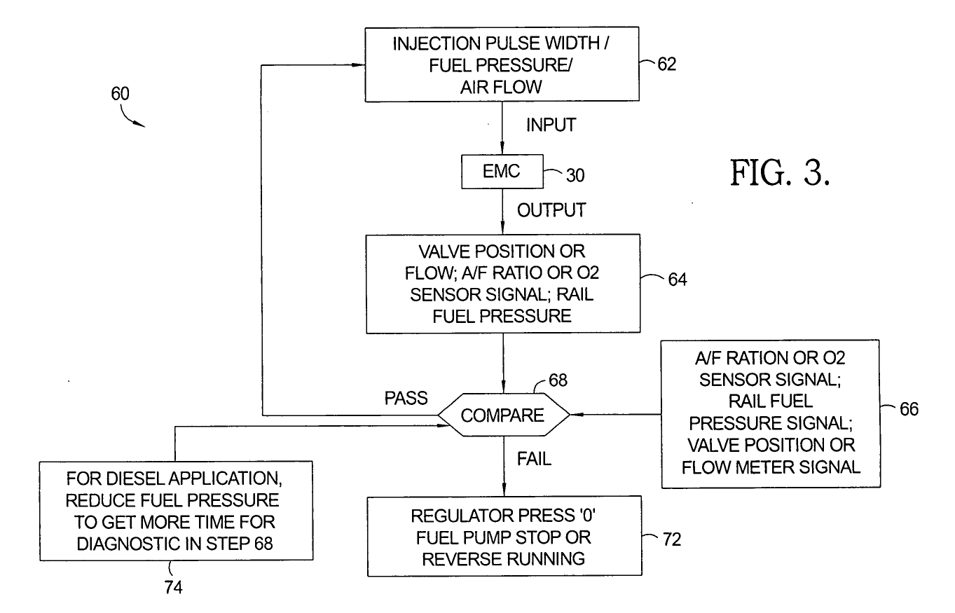

Referring to FIG. 3, system control logic 60 of flow sensing fuel system 10 shown in FIG. 1 during engine operation includes a step 62 where input data, such as injector input pulse width 48, fuel pressure, and air flow, are provided by sensors of the engine management systems (EMS) to engine control module (ECM) 30 (FIG. 1). For example, fuel pressure input data may be provided by fuel pressure sensor 14 shown in FIG. 1, air flow input data may be provided by an air flow meter 36 (FIG. 1) that monitors the intake air flow of an engine and injector pulse width 48 (FIG. 2) may be predetermined by ECM 30 itself based on air flow in previous ECM 30 data sampling period. From the input data, ECM 30 can calculate output data based on the input data, such as valve position or flow conditions between fuel pump 22 and fuel rail 20, A/F ratio of emission gas or oxygen content of emission gas, and rail fuel pressure signal 42, in a following step 64. A step 66 involves measuring control signals 40, such as A/F signal 54 or oxygen signal 52, rail fuel pressure signal 42, and valve position or flow meter signal 44, to ECM 30. The control signals 40 are compared to the calculated output data in step 68. If the control signals 40, such as A/F signal 54 or oxygen signal 52, rail fuel pressure 42, and valve position or flow meter signal 44, do match the calculated output data for control signals 40, for example, within preset limits, then ECM 30 obtains new input data from the sensors in step 62. If the control signals 40, such as A/F signal 54 or oxygen signal 52, fuel rail pressure signal 42, and valve position or flow meter signal 44, do not match the calculated output data for control signals 40, for example, within preset limits, then ECM 30 sends in a step 72 a command to controllable pressure regulator 16 and fuel pump 22 (FIG. 1) that turns regulator pressure 46 off and stops operation of fuel pump 22 to end fuel supply from pump 22 to fuel rail 20, and possibly reverses operation of fuel pump 22 to draw back fuel from fuel rail 20 to fuel tank 24 under some conditions, such as deactivating controllable check valve 26 (FIG. 1). For application of system control logic 60 in a fuel system 10 for common rail diesel engines, the fuel pressure may be reduced in a step 74 while the diagnostics in step 68 are being completed.

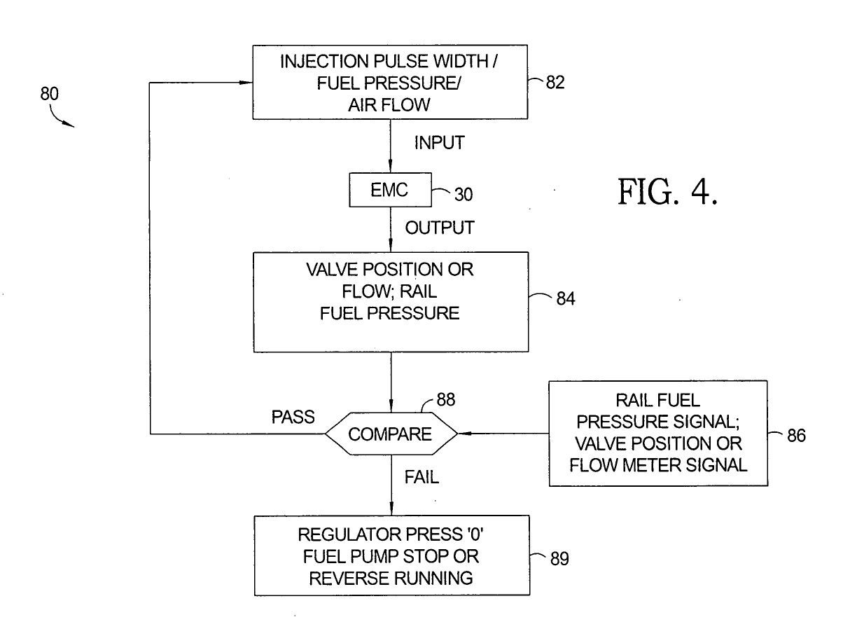

Referring to FIG. 4, system control logic 80 of flow sensing fuel system 10 shown in FIG. 1 during engine start-up includes a step 82 where input data, such as injector input pulse width 48, fuel pressure, and air flow, are provided by sensors of the engine management systems (EMS) to engine control module (ECM) 30 (FIG. 1). For example, fuel pressure input data may be provided by fuel pressure sensor 14 shown in FIG. 1, air flow input data may be measured by an air flow meter 36 (FIG. 1) that monitors the intake air flow of an engine, and injector pulse width 48 (FIG. 2) may be predetermined by ECM 30 itself based on air flow in previous ECM 30 data sampling time period. From the input data, ECM 30 can calculate output data, such as valve position of flow monitoring device 12 or flow conditions between fuel pump 22 and fuel rail 20 and rail fuel pressure signal 42, in a following step 84. A step 86 involves measuring control signals 40, such as fuel rail pressure signal 42 and valve position or flow meter signal 44, to ECM 30. The control signals 40 are compared to the calculated output data in a step 88. If the control signals 40, such as fuel rail pressure signal 42 and valve position or flow meter signal 44, are comparable to the calculated output data for control signals 40, for example, within preset limits, then ECM 30 obtains new input data from the sensors in step 82. If the control signals 40, such as fuel rail pressure signal 42 and valve position or flow meter signal 44, are not comparable to the calculated output data for control signals 40, for example, within preset limits, then ECM 30 sends in a step 89 a command to controllable pressure regulator 16 and fuel pump 22 (FIG. 1) that turns regulator pressure 46 off and stops operation of fuel pump 22 to end fuel supply from fuel pump 22 to fuel rail 20, and possibly reverses operation of fuel pump 22 to draw back fuel from fuel rail 20 to fuel tank 24 under some conditions, such as deactivating controllable check valve 26 (FIG. 1).

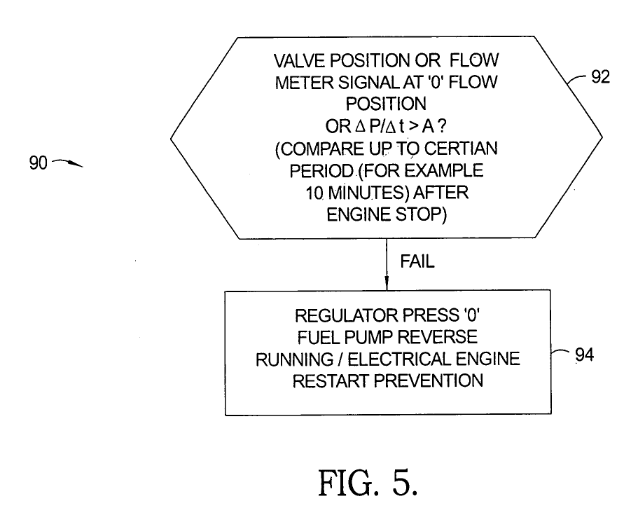

Referring to FIG. 5, system control logic 90 of flow sensing fuel system 10 shown in FIG. 1 after engine shut down includes a step 92 where valve position or flow meter signal 44 from flow monitoring device 12 (FIG. 1) indicates zero flow condition. In step 92, ECM 30 receives a rail fuel pressure signal 42 from fuel pressure sensor 14 (FIG. 1) several times for a certain time period after the engine has stopped, for example, 10 minutes, such that a pressure drop ΔP over a predetermined time period Δt is obtained. The pressure drop ΔP over time period Δt is then compared by ECM 30 to a predetermined value “A” typical for zero flow conditions after engine shut down. If the pressure drop in fuel rail 20 is too fast (ΔP/Δt>A), then ECM 30 sends in a step 94 a command to controllable pressure regulator 16 and fuel pump 22 (FIG. 1) that turns regulator pressure 46 off to relieve pressure and operate the fuel pump 22 to draw back fuel from fuel rail 20 to fuel tank 24. Step 94 may further involve electrical engine restart prevention, which electrically locks the engine to prevent restart of an engine in which a large fuel leak occurred. A faster than normal fuel rail pressure drop after engine shut down may indicate one or more stuck open injectors 18 or a leak to the environment in the fuel rail 20 or the sealing areas between fuel rail 20 and injectors 18.

By integrating flow monitoring device 12, fuel pressure sensor 14, and controllable pressure regulator 16 in existing fuel systems for MPFI and GDI engines and for common rail diesel engines, flow sensing fuel system 10 is provided that protects the engine and limits the fuel leaking into the environment in case of a stuck open condition or sealing problem of one or more injectors 18 or in case of a leak in the fuel rail 20. Flow monitoring device 12, fuel pressure sensor 14, and controllable pressure regulator 16 in combination with a prior art oxygen sensor 34 or A/F sensor 32 enable monitoring the fuel flow under real time engine conditions, such as during engine start-up, during engine operation, and after engine shut down.

Flow sensing fuel system 10 (FIG. 1) protects MPFI and GDI engines and common rail diesel engines from hydraulic lock or emission system damage due to injector contamination or vehicle electrical harness problems causing excessive flow or leak, and prevents high flow fuel leakage to the environment due to fuel system component leakage. Flow sensing fuel system 10 further enables identification of injector malfunctions, such as stuck open or stuck close conditions, as soon as the engine is started and also after engine operation is stopped. Furthermore, integrating a flow limit valve into flow sensing fuel system 10 may reduce fuel pressure pulsations, since the flow limit valve operates as a damper. Therefore, fuel metering variations within a given injector or injector to injector can be reduced compared to fuel systems without a damper.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A flow sensing fuel system for multiple port fuel injection gasoline engines, gasoline direct injection engines, or common rail diesel engines, comprising:
a flow monitoring device positioned in a fuel flow passage between a fuel pump and a fuel rail;
a fuel pressure sensor in fluid communication with said fuel rail; and
a controllable pressure regulator positioned at an outlet of said fuel pump.

2. The fuel system of claim 1, further comprising an engine control module, wherein said engine control module receives control signals from said flow monitoring device and from said fuel pressure sensor, and wherein said engine control module sends commands to said controllable pressure regulator.

3. The fuel system of claim 1, further including an oxygen sensor or an air to fuel ratio sensor, wherein an engine control module receives control signals from said oxygen sensor or said air to fuel ratio sensor.

4. The fuel system of claim 1, wherein said flow monitoring device monitors the fuel flow from said fuel pump to said fuel rail.

5. The fuel system of claim 1, wherein said flow monitoring device is an on/off flow control valve.

6. The fuel system of claim 1, wherein said flow monitoring device is a continuous position identification valve.

7. The fuel system of claim 1, wherein said flow monitoring device is a flow meter.

8. The fuel system of claim 1, wherein said fuel pressure sensor monitors the fuel pressure in said fuel rail.

9. The fuel system of claim 1, wherein said controllable pressure regulator receives a command from an engine control module to release fuel pressure in said fuel rail.

10. The fuel system of claim 1, wherein said fuel pump receives a command from an engine control module to stop operation to prevent supplying fuel to said fuel rail or to reverse operation to draw back fuel from said fuel rail to a fuel tank.

11. The fuel system of claim 1, further comprising an engine control module, wherein said engine control module utilizes control signals including rail fuel pressure, valve position or flow meter signal, injector input pulse width, oxygen signal or air to fuel ratio signal from emission gas, fuel pressure, air flow, and regulator pressure during engine operation.

12. The fuel system of claim 1, further comprising an engine control module, wherein said engine control module utilizes control signals including rail fuel pressure, valve position or flow meter signal, injector input pulse width, fuel pressure, air flow, and regulator pressure signal during engine start-up.

13. The fuel system of claim 1, further comprising an engine control module, wherein said engine control module utilizes control signals including rail fuel pressure, valve position or flow meter signal, and regulator pressure after engine shut down.

14. A method for monitoring the fuel flow in a fuel system of a multiple port fuel injection gasoline engine, a gasoline direct injection engine, or a common rail diesel engine, comprising the steps of:
providing input data obtained by sensors of an engine management system to an engine control module;
calculating output data based on said input data with said engine control module;
providing control signals obtained by a flow monitoring device positioned in the flow path from a fuel pump to a fuel rail and by a fuel pressure sensor in fluid communication with said fuel rail to said engine control module;
comparing said control signals to said output data with said engine control module;
sending a command from said engine control module to a controllable pressure regulator if said control signals do not match said output data; and
sending a command from said engine control module to a fuel pump if said control signal does not match said output data.

15. The method of claim 14, further including the step of:
reducing fuel pressure to provide more time for data diagnostics for common rail diesel applications.

16. The method of claim 14, further including the step of:
terminating fuel supply from said fuel pump to said fuel rail.

17. The method of claim 14, further including the steps of:
reversing operation of said fuel pump; and
drawing back fuel from said fuel rail to a fuel tank with said fuel pump.

18. The method of claim 14, further including the step of:
indicating zero flow condition with said flow monitoring device after engine shut down;
providing a rail fuel pressure signal obtained by said fuel pressure sensor to said engine control module for a predetermined time period after said engine shut down;
calculating a pressure drop over said time period;
comparing said calculated pressure drop to a normal pressure drop;
sending a command from said engine control module to a controllable pressure regulator to relieve pressure if said calculated pressure drop is faster than said normal pressure drop; and
electrically preventing engine restart.

19. A method for detection an abnormal fuel flow in a fuel system of a multiple port fuel injection gasoline engine, a gasoline direct injection engine, or a common rail diesel engine during engine operation, comprising the steps of:
obtaining input data including injector pulse width, fuel pressure, and intake air flow as input data;
calculating output data including valve position or flow condition between a fuel pump and a fuel rail, air to fuel ratio or oxygen content of emission gas, and rail fuel pressure based on said input data;
obtaining control signals including valve position or flow meter signal, air to fuel ratio signal or oxygen signal, and rail fuel pressure;
comparing said control signals with said output data;
controlling regulator pressure to zero and stop operation of said fuel pump and to reverse operation of said fuel pump if said control signals do not match said output data.

20. The method of claim 19, further including the step of:
reducing fuel pressure in a fuel system of a diesel engine during comparison of said control signals with said output data.

21. A method for detecting an abnormal fuel flow in a fuel system of a multiple port fuel injection gasoline engine, a gasoline direct injection engine, or a common rail diesel engine during engine start-up, comprising the steps of:
obtaining input data including injector pulse width, fuel pressure, and intake air flow as input data;
calculating output data including valve position or flow condition between a fuel pump and a fuel rail and rail fuel pressure based on said input data;
obtaining control signals including valve position or flow meter signal and rail fuel pressure;
comparing said control signals with said output data; and
controlling regulator pressure to zero and stop operation of said fuel pump if said control signals do not match said output data.

22. The method of claim 21, further comprising the step of reversing the operation of said fuel pump.

23. A method for detection an abnormal fuel flow in a fuel system of a multiple port fuel injection gasoline engine, a gasoline direct injection engine, or a common rail diesel engine after engine shut down, comprising the steps of:
determine zero flow condition between a fuel pump and a fuel rail;
obtaining rail fuel pressure data over a predetermined time period after said determination of zero flow condition;
calculating pressure drop over said time period;
comparing calculated pressure drop to a normal pressure drop;
controlling regulator pressure to zero and reverse operation of said fuel pump if said calculated pressure drop is faster than said normal pressure drop; and
electrically preventing engine restart.

24. The method of claim 23, further comprising the step of detecting a stuck open injector or a gross leak in the fuel system if said calculated pressure drop is faster than said normal pressure drop.
